(19) United States
(12) Patent Application Publication
(10) Pub. No.: US 2003/0046107 A1
(43) Pub. Date: Mar. 6, 2003

(54) METHOD OF PROVIDING AND BILLING FOR MEDICAL SERVICES

(76) Inventors: JOEL H. EISENBERG, EASTON, CT (US); MITCHELL S. EISENBERG, FAIRFIELD, CT (US)

Correspondence Address: DAVID L. FEIGENBAUM, ESQ., FISH & RICHARDSON, 225 FRANKLIN STREET, BOSTON, MA, 021102804

(21) Appl. No.: 08/562,545

(22) Filed: Nov. 20, 1995

(51) Int. Cl. G06F 17/60

(52) U.S. Cl. 705/2; 705/4; 705/39; 705/40

(57) ABSTRACT

A method of providing medical services comprises assigning trained medical representatives from a central office, who are employed by the central office, to locations remote from the central office, providing medical services to patients by the medical representatives at each location while linked to and under the supervision of a licensed physician and billing each patient for medical services provided to that patient by the medical representative through said licensed physician. The patient, licensed physician or medical representative submits the bill to an insurer for reimbursement. The method fulfills all of the responsibilities, duties and services of a trainer at a school without the school paying for the professional service, thereby eliminating the need and expense of a trainer at a school.

### BACKGROUND OF THE INVENTION

The present invention relates to a method for providing medical services and billing for those services.

Many schools utilize trainers for student athletes. The trainers are employed by the school and work for salaries, because they are not permitted to charge for medical services.

As a result of the fact that the trainer cannot charge the athletes for the services rendered, there can be no reimbursement under health insurance and the school must bear the cost of the trainer's salary.

### SUMMARY OF THE INVENTION

The main object of the present invention is to eliminate the disadvantages of the present “trainer” system and provide an improved method for providing medical services and billing for those services.

In accordance with the present invention, the trainer is substituted by a medical representative of a licensed physician, who is employed by and under the supervision of the licensed physician at a central office and is able to diagnose and treat the student athletes on the field, in the training room and in other venues, which are remote from the central office. The medical representative is supervised by a licensed physician.

The medical representative would be working for a physician and charge each student under the physician's tax I.D. number. Thus, the medical representative can be a non-physician including a physician's assistant, physical therapist, occupational therapist, any type of physician extender, or the medical representative can be a physician.

Each patient, e.g., a student athlete, would be billed for the medical services provided to that patient by the medical representative. The billing would be through a licensed physician at the central office. Where the medical representative is a physician or a physical therapist, or any medical care provider where the state statutes allow the provider to independently bill for services, the billing can be directly by the medical representative at the remote facility.

The patient, licensed physician or medical representative can then submit the bill to an insurer for reimbursement.

The method according to the present invention has many advantages to the school, the patient and the care providers. By essentially subcontracting the services, duties, obligations, responsibilities and authority of the trainer to another, the school would not be liable for any negligence or malpractice by the medical representative. Moreover, if every student is required to have health insurance, the services provided by the medical representative will be reimbursed by an insurer, and the school will no longer have to bear the cost of a trainer. The same is true if the student has insurance on a voluntary basis. Once a contract is made with a school, the school has no expense for the professional services and the organization of the medical representative is paid by the insurer and the student or one of various insurer/patient combinations. The school may remain without an expense for the medical professional services.

The patient has the advantage of having a more highly trained care provider, who is under the supervision of a licensed physician, to treat the patient. The medical representative would be able to legally provide ultrasound and electrical stimulation, and other modalities and prescription drugs to the patients.

The method according to the present invention is also advantageous to the school, since the medical representative can also be available to non-team students, staff and to the non-college community. The medical representative can also be used for community activities and in industry. The system also provides the school with the advantage of having a medical representative on site who can provide continuing sports medicine education. The system has the advantage of permitting the establishment of standards for credentials, constant centralized consultation and a supply of substitute medical representatives.

The training of the medical representatives can be at a central office of a licensed physician who performs the training or at an off-site training facility. Preferably, the medical representative would be certified by that training facility.

Furthermore, in accordance with the present invention, the medical representatives can be used either to substitute for or to supplement the trainers that are present at a school or other facility.

The medical representative can be a chiropractor, a conventional medical doctor, a physical therapist, a physician's assistant, a nurse practitioner, an occupational therapist or any appropriately educated physician extender.

The central office of the licensed physician can have substitute medical representatives available for a particular location if the originally assigned medical representative is not available.

The central office also has the economy of scale for providing an inventory of medical representatives, purchasing equipment, negotiating with insurance companies, contracting with physicians and other providers for other care and performing outcome studies to increase the quality care of the population.

The central office can also provide for continuing medical education to the medical representatives and a constant consultation.

Moreover, where the patients in the school community have insurance, which requires in-plan physicians for further treatment, arrangements can be made with those in-plan doctors for smooth medical transition. In a preferred embodiment of the present invention, the medical representative is within the plan of each of the patients. In another embodiment the in-plan physicians are associated as “associates”, “employees”, “partners” or some such relationship with the organization of this invention. Ideally, education and credentialling will be given to these associated physicians.

The medical representative is preferably educated by the central office and is placed in a system of constant communication, for example, by cellular phone or on-line computer communication. The medical representatives can also participate as educators at the schools, not only to the patients, but as part of the academic courses. In this way, the schools can be further compensated for the use of their facilities by the medical representative.

The method according to the present invention will allow the different remote facilities to participate with each other. This allows this medical portion of various facilities to cross pollinate and to cooperate and improve and upgrade the quality of care at the schools and other sites.

These and other advantages of the present invention are achieved in accordance with the present invention disclosed in further detail in the following with reference to the attached drawings, wherein:

### BRIEF DESCRIPTION OF THE DRAWINGS

FIG. 1 is a block diagram of a system for carrying out the method of the present invention;

FIG. 2 is a schematic of the central office of FIG. 1;

FIG. 3 is a schematic of each remote facility shown in FIG. 1; and

FIG. 4 is a flow chart of one embodiment of the method according to the present invention.

### DETAILED DESCRIPTION OF THE INVENTION

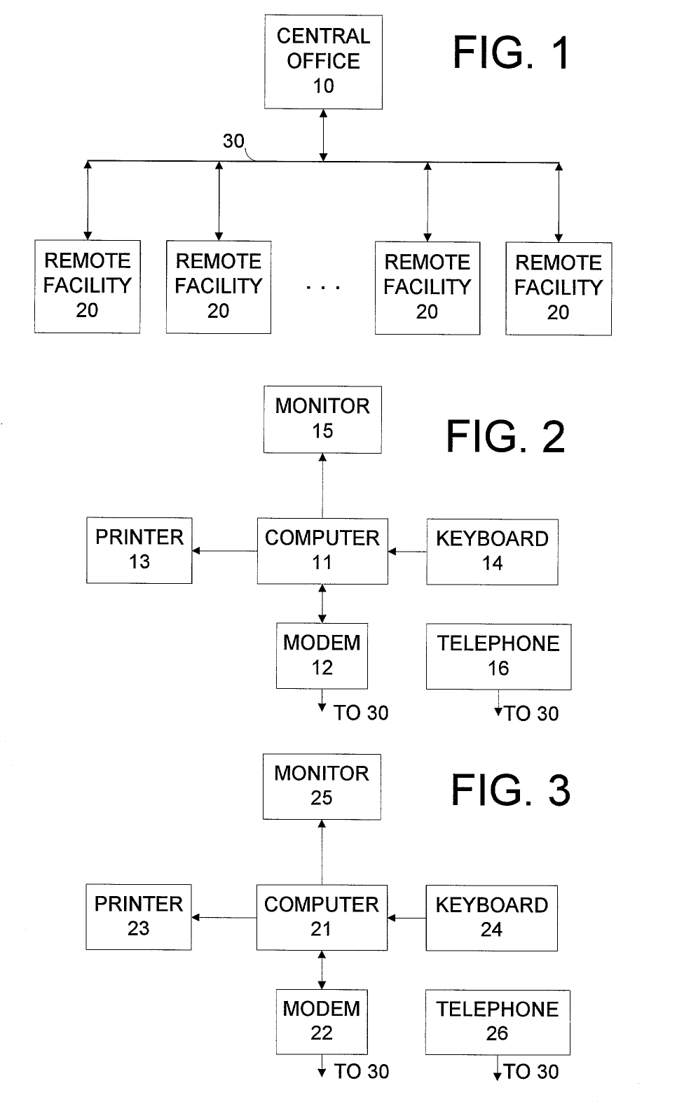

Referring now to FIGS. 1-3, in accordance with the present invention, a central office 10 communicates with one or more remote facilities 20 via a communication network 30.

The central office 10 can be a medical office, hospital or other facility in which a licensed physician is available for consultation and supervision of a medical representative at a remote facility 20.

The remote facility 20 is at a school or other educational institution, a camp, clinic, professional sports facility, a factory or other industrial or commercial facility, etc. In a preferred embodiment of the present invention, the remote facility is in the athletic department of a school where medical services are to be provided to student athletes.

The communication network 30 is preferably a telephone network but can also be a wired or wireless communication network.

The central office includes a computer 11 such as a Pentium based or Macintosh computer, a high speed modem 12 for communicating information over the network 30 to and from the computer 11, a keyboard 14 for inputting information, a printer 13 under the control of computer 11 and a monitor or display 15 for display information. Also included is telephone 16 for communicating voice data over the network 30. Each remote facility includes a computer 21 such as Pentium based or Macintosh computer, which communicates with the network 30 via a high speed modem 22, a keyboard 24 for inputting information, a printer 23 under the control of computer 21 and a monitor 25 for displaying information to a user. The remote facility also includes a telephone 26 for communicating voice data over network 30.

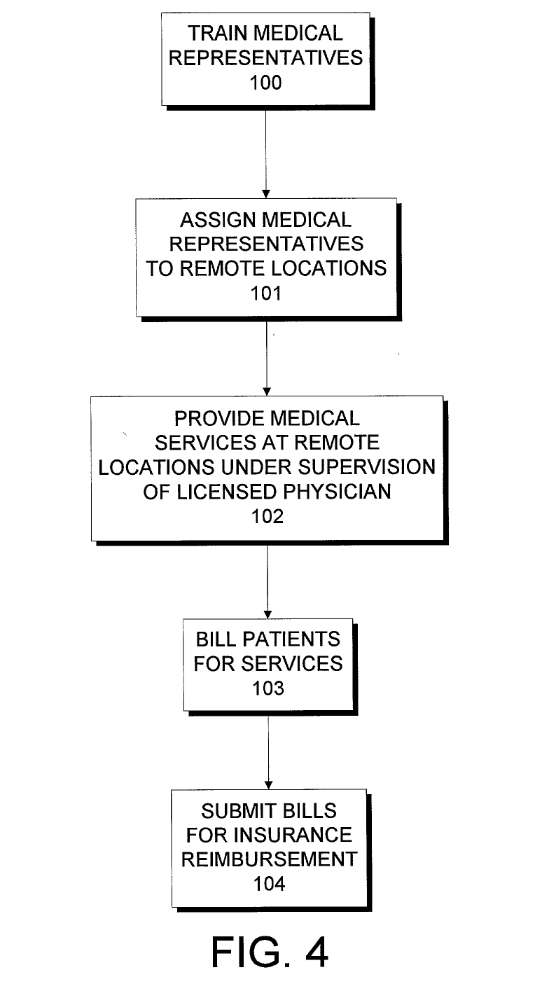

The method according to the present invention is shown in FIG. 4.

In a first step 100, medical representatives are trained, preferably by a licensed physician at the central office 10 or at an off-site facility. The medical representatives are preferably certified as having achieved a pre-established standard of medical care as a result of the training.

In the next step 101, the medical representatives are assigned as employees of the licensed physician or central office to a remote location where there is a facility 20. The assignment can be at no charge to the location or a payment for use of the facility may be made to the location.

At that remote location, each medical representative provides medical services in step 102 linked to and under the supervision of a licensed physician at the central office 10 or at the remote location if possible. The supervision is preferably carried out on-line, where computer 21 is connected to computer 11 via the modems 12 and 22 and the network 30. Alternatively, the medical representative at the remote location can have a cellular telephone and communicate with a licensed physician at the central office 10.

By means of providing a computer 21 at each remote facility 20, the medical representative can input patient and medical service information via the keyboard 24 or by voice input over telephone 26. This information is then downloaded to computer 11 at the central office. Thereafter, the patient can be billed through the licensed physician at the central office 10 by either printing the bill at printer 13 at the central office or having computer 11 instruct computer 21 to print the bill on printer 23 at the remote facility 20. Where the law allows the actual provider to bill for services, the medical representative can bill the patient directly or bill the patient's insurance. While all of these operations can be performed manually, the above system is far superior.

The bills created in step 103 can be submitted for insurance reimbursement in step 104 by the licensed physician at the central office 10, by the medical representative at the remote facility 20 or by the patient.

It is understood that the embodiments described hereinabove are merely illustrative and are not intended to limit the scope of the invention. It is realized that various changes, alterations, rearrangements and modifications can be made by those skilled in the art without substantially departing from the spirit and scope of the present invention.

What is claimed is:

1. A method of providing medical services comprising the steps of:
assigning trained medical representatives from a central office and employed by the central office to locations remote from the central office;
providing medical services to patients by the medical representatives at each location while linked to and under the supervision of a licensed physician; and
billing each patient for medical services provided to that patient by the medical representative;
whereby one of the patient, licensed physician and medical representative submits the bill to an insurer for reimbursement.

2. The method according to claim 1, wherein the step of providing medical services under supervision comprises maintaining a cellular telephone link between each medical representative and a licensed physician at the central office.

3. The method according to claim 1, wherein the step of providing medical services under supervision comprises maintaining an on-line computer link between each medical representative and a licensed physician at the central office.

4. The method according to claim 1, wherein the step of billing comprises maintaining a computer link between each medical representative and a licensed physician at the central office, transferring billing information from each medical representative to the central office via the computer link, billing each patient through the licensed physician and producing a bill at the central office or the remote location.

5. The method according to claim 1, wherein the remote locations comprise schools.

6. The method according to claim 5 wherein the patients are students.

7. The method according to claim 6, wherein the students are athletes.

8. The method according to claim 1, further comprising training the medical representatives by the licensed physician.

9. The method according to claim 8, wherein the training is at the central office.

10. The method according to claim 8, wherein the training is off-site from the central office.
